(19) United States
(12) Patent Application Publication
(10) Pub. No.: US 2002/0055915 A1
(43) Pub. Date: May 9, 2002

(54) System and method for high speed string matching

(76) Inventor: Greg Zhang, San Jose, CA (US)

Correspondence Address: OPPENHEIMER WOLFF & DONNELLY, P. O. BOX 10356, PALO ALTO, CA, 94303, US

(21) Appl. No.: 09/796,881

(22) Filed: Feb. 28, 2001

Related U.S. Application Data
(60) Provisional application No. 60/185,559, filed on Feb. 28, 2000.

(51) Int. Cl. G06F 7/00

(52) U.S. Cl. 707/1

(57) ABSTRACT

An apparatus and method for locating a data object corresponding to an input string. A plurality of tables is constructed in a memory to support the recognition of one or more input strings. For each input string supported there are a chain of tables linked together. Each table in the chain corresponds to a segment of the input string and has entries that contain a data object pointer field and a next table pointer field. Upon receipt of a segment of an input string, a key is computed for the segment to obtain an entry in a table corresponding to the segment. If the entry indicates there is another table in the chain, the next segment is obtained, its key computed and the table entry obtained. This continues until the last table is found. The data object pointed to by the data object pointer is then retrieved.

### CROSS-REFERENCE TO RELATED APPLICATIONS

This application claims priority from U.S. Provisional Application, SN 60/185,559, filed on Feb. 28, 2000, and entitled “String Index and Look-Up Method”, which application is hereby incorporated by reference into the present application.

### FIELD OF THE INVENTION

The present invention relates generally to the real-time accessing of information based on high speed indexing, and more particularly to the real-time accessing of information using a plurality of keys formed in real-time from incoming information.

1. Description of the Related Art

Hypertext documents that are transferred from servers to client machines have become increasingly complex. These documents contain many separate sections, such as in-line images, tables, text areas, buttons, and, audio and video clips, and advertisements, each of which is treated as a separate data object. When a document is delivered by the server to the client requesting the document, not only must the document be obtained by the server but all of the data objects for the separate sections must also be delivered. The net effect of delivering these complex documents to a client machine is that the server must handle a large number of requests in a timely manner, one for the document and one for each separate section that needs to be retrieved.

In the HyperText Transfer Protocol (HTTP) used in the World Wide Web Application, each request to the server includes an Uniform Resource Locator (URL) string (or a Uniform Resource Identifier, URI). URIs can be quite long (the length of an URI is not fixed by the protocol) and the large number of them that arrive at the server when a complex document is requested creates a problem for the server. The server must quickly identify the URI, locate and retrieve for the client machine the target data object to which the URI points. With hundreds of URIs possibly being requested for a single document, identifying the URI contributes an appreciable amount of time to serving the document request.

Presently, URIs are identified by software that runs on the server, which takes an appreciable amount of time to perform this task. For servers that support high speed connections (in the range of 10-100 Gigabits per second) to client machines over the Internet, it is highly desirable to reduce the time it takes to identify an input string, such as an URI, so that the benefit of the high speed connection can be more fully realized.

2. Brief Summary of the Invention

The present invention is directed towards this need. A method of locating a data object, in accordance with the present invention, uses a plurality of tables. Each table has a base address and one or more entries that each include a data object pointer and a next table base address. The data object is specified by an input string and this string is divided into an ordered set of two or more segments. A segment is a predetermined length of the input string and corresponds to an entry in one of the tables. In the method, one of the segments of the input string is obtained and a key is calculated for the segment. The base address for the table having the entry for the segment is next obtained and the location of an entry is determined based on the key and the table base address. If the entry points to another table, then the base address of that table is obtained. If the entry does not point to another table, then the data object pointer is used to fetch the data object corresponding to the input string.

One advantage of the present invention is that strings can be identified as they are transmitted to the server so that by the time the entire string has arrived the location of the target data object has been determined.

Another advantage is that large complex documents can be delivered to the client machine by the server in a shorter overall time because the time to identify the URI and the target file to which it points is drastically reduced.

### BRIEF DESCRIPTION OF THE DRAWINGS

These and other features, aspects and advantages of the present invention will become better understood with regard to the following description, appended claims, and accompanying drawings where:

FIG. 1 shows a representative system in which the present invention operates;

FIG. 2 shows a representative client or server computing system;

FIG. 3 shows a first table format in accordance with the present invention;

FIG. 4 shows a second table format in accordance with the present invention;

FIG. 5 shows a flow chart for the construction of tables in the server to represent the identifier strings supported by the server;

FIG. 6 shows a chain of tables corresponding to a particular input string;

FIG. 7 shows a chain of tables corresponding to two input strings; and

FIG. 8 shows a flow chart for locating a data object corresponding to an input string.

### DETAILED DESCRIPTION OF THE INVENTION

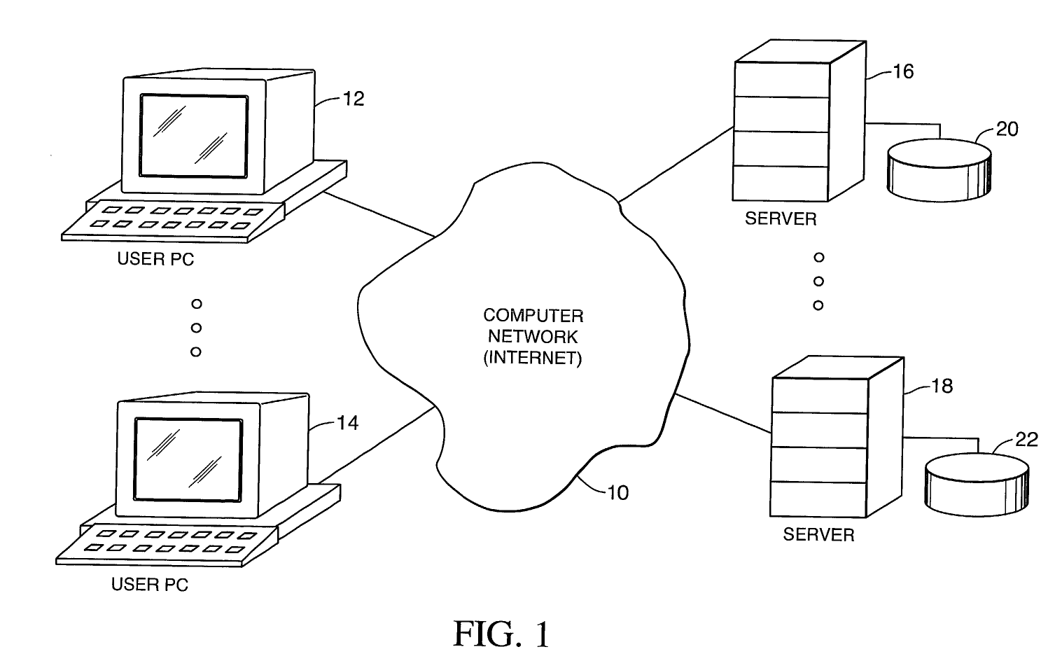

FIG. 1 shows a representative system in which the present invention operates. A computer network 10 such as the Internet connects to one or more client computer systems 12, 14 to one or more server systems 16, 18. The server systems 16, 18 operate to receive requests from the client computer systems 12, 14 and return documents and data in response to those requests. Commonly such documents and data are stored on a permanent storage device 20, 22 connected to the server system. When the servers are hosting a World Wide Web (WWW) Application, the servers receive requests according to the HyperText Transfer Protocol. These requests can include Uniform Resource Identifiers (URIs) for specifying the document that the client machine is seeking. The Server hosting a Web Application has information about each and every document and document section that the Server can make available to a client. Any documents or document sections that are accessible by the client must have an URI that identifies those documents or sections.

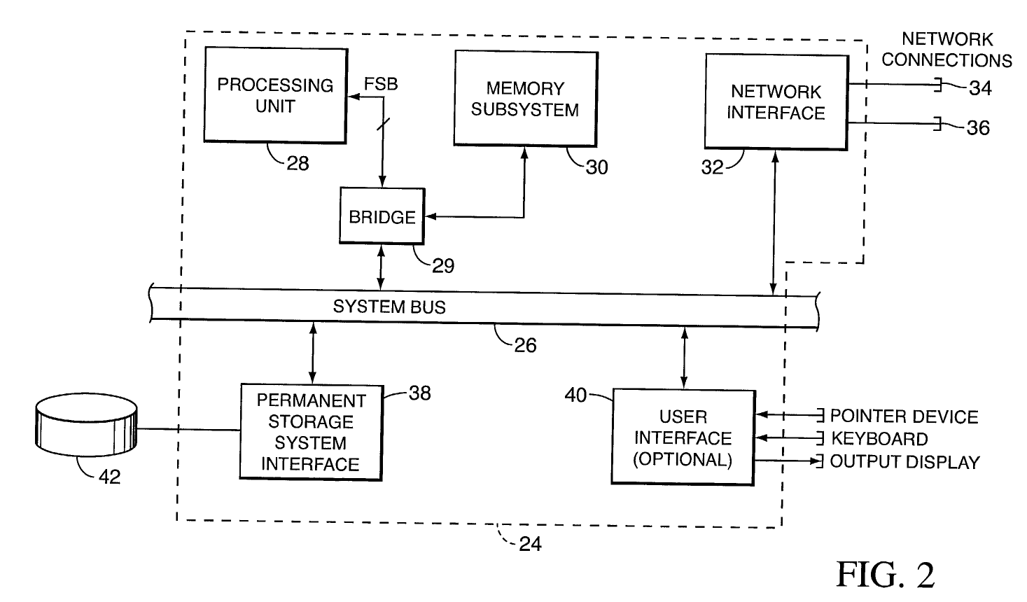

A representative client or server system 24 is illustrated in FIG. 2. A system bus 26 interconnects a bridge device 29 that couples a processing unit 28 to a memory subsystem 30, a network interface 32 to support one or more network connections 34, 36 to the computing system 24, a permanent storage system 38 for holding persistent data related to the tasks of the computing system 24, and a user interface 40, which is optional depending on whether the computing system 24 is representative of a server system or client system. The memory subsystem 30 holds programs that contain instructions for execution by the central processing unit 28. Programs can be loaded from the storage 42 of the permanent storage system or from the network interface 32. In accordance with a program in the memory system, the computing system 24 is configured to process information from the network interface 32 including requests for data, access data from permanent storage 42 and transmit said data on the network 34 36 in response to the request for data. A user may interact with the computing system 24 via a keyboard, pointing device and a visual display unit (not shown). Alternatively, the computing system 24 illustrated in FIG. 2 is one of many computing systems configured for a particular task, such as that of handling network traffic received and sent over the network connection.

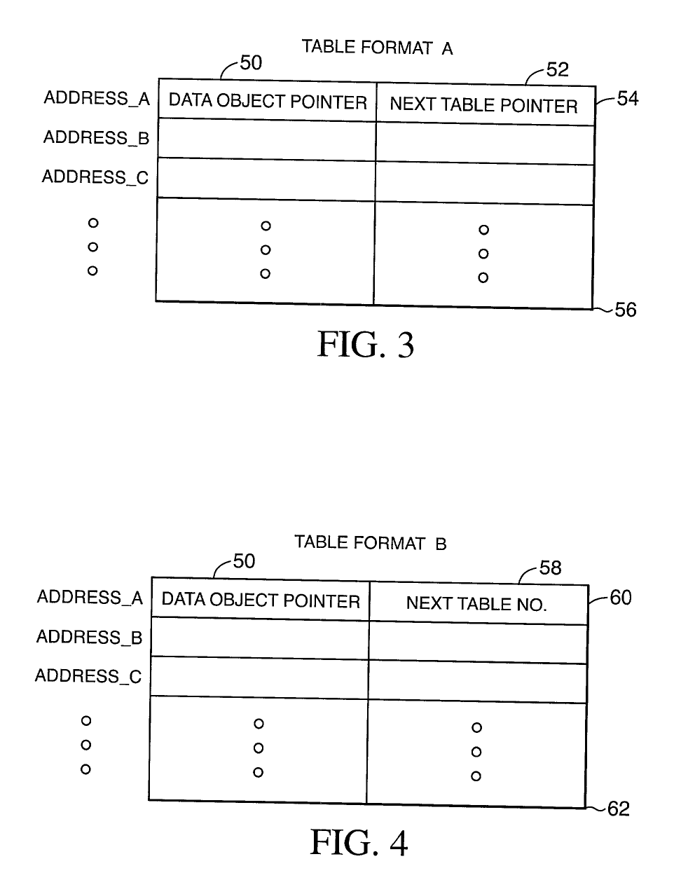

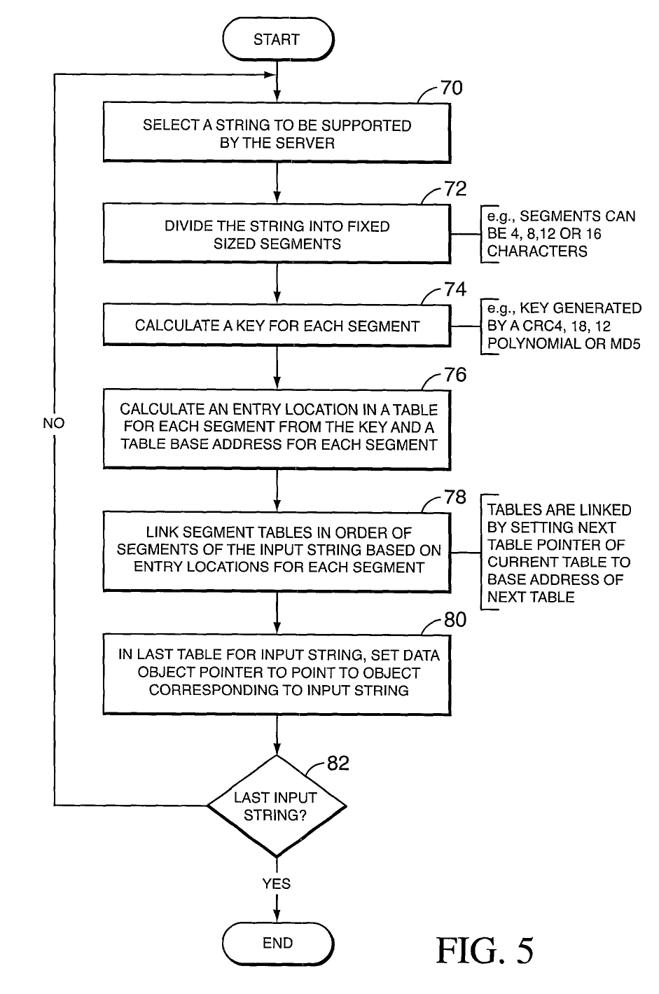

Given the thousands or tens of thousands of URIs a Server hosting a Web application must locate, the present invention provides an efficient method for locating the data object which the URI is requesting. FIG. 5 shows a flow chart for the construction of tables in the server to represent the identifier strings supported by the server, FIG. 3 shows a first table format in accordance with the present invention and FIG. 4 shows a second table format in accordance with the present invention.

Table format A, shown in FIG. 3, has two fields 50, 52 in each table entry. The first field 50 is the data object pointer and the second field is the next table pointer 52. The next table pointer 52 is a pointer that links an entry in the current table 56 to the next table in a chain of tables by pointing the table base address of the next table. The data object pointer 52 is configured to point to the data object corresponding to an URI. In the table at the end of the chain, the next table pointer is null and the data object pointer is valid, pointing to the object corresponding to the URI. In the other tables, for used entries, the data object pointer is null and the next table pointer is valid. Table format B, shown in FIG. 4, has two fields 50, 58 in each table entry 60, but the second field 58 is a next table number. This format is used when the tables are placed in a certain order so that they can be referenced by a position in that order.

Referring to FIG. 5, a flow chart for the construction of tables in the server to represent the identifier strings supported by the server, is set forth. First, in step 70, a string (such as a URI) that is supported by the server is selected. Next, in step 72, the character string that makes up the string is divided into fixed-length segments. A fixed-length segment can include, for example, 4, 8, 12 or 16 characters. Each fixed-length segment is then used, in step 74, to generate a key using a key generation method that ensures that different fixed-length strings have different keys. For example, a CRC4, CRC8 or CRC12 polynomial code can be used to generate keys for the segments. The MD5 hash function is another example of a function that can be used to generate a key.

Next, in step 76, an entry location in a table for each segment is calculated based on the key, a table base address and the size of the table entry. If the size of an entry is 8 bytes, then the table entry location is table_base_address+8*key, where table_base_address is the address in memory of the first location in the table and key is the key generated for the segment. In step 78 the tables are linked together in the order of the segments that make up the string based on the entry locations for each segment. This is done by setting the next table pointer of the entry of a current table to the base address of the next table in the sequence. In step 80, for the last table, the data object pointer is set to point to the object corresponding to the string. Finally, in step 82, a test is made to determine whether more input strings which are supported by the server need to have tables or table entries generated.

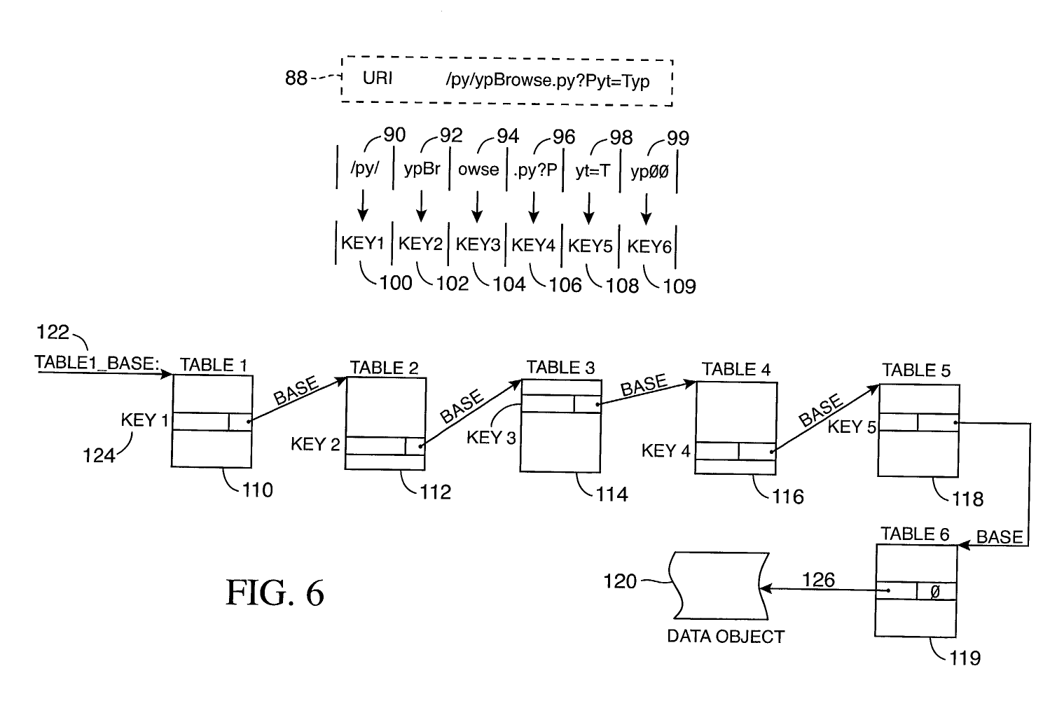

FIG. 6 shows a chain of tables corresponding to a particular input string, such as the URI 88 shown. In the figure, there are six segments 90, 92, 94, 96, 98, 99 into which the URI 88 (or portion of the URI) is divided. A key for each segment is calculated and designated as key1 100, key2 102, key 3 104, key4 106, key5 108 and key6 109. A table entry location is calculated for each key based on the table base address, the key and the size of the entry. For segment 1, table base address 122 for table 1 110 is used and the entry location 124 for that segment is table1_base_address+(entry size)*key. The tables 110, 112, 114, 116, 118 and 119 are linked in the order of the segments that make up the string by entering the proper base address into the next table pointer of an entry in a previous table. In the final table, table 5 119 in the figure, the data object pointer 126 is set to point to the data object 120 corresponding to the URI and there is no entry (or it is set to null) for the next table pointer 128.

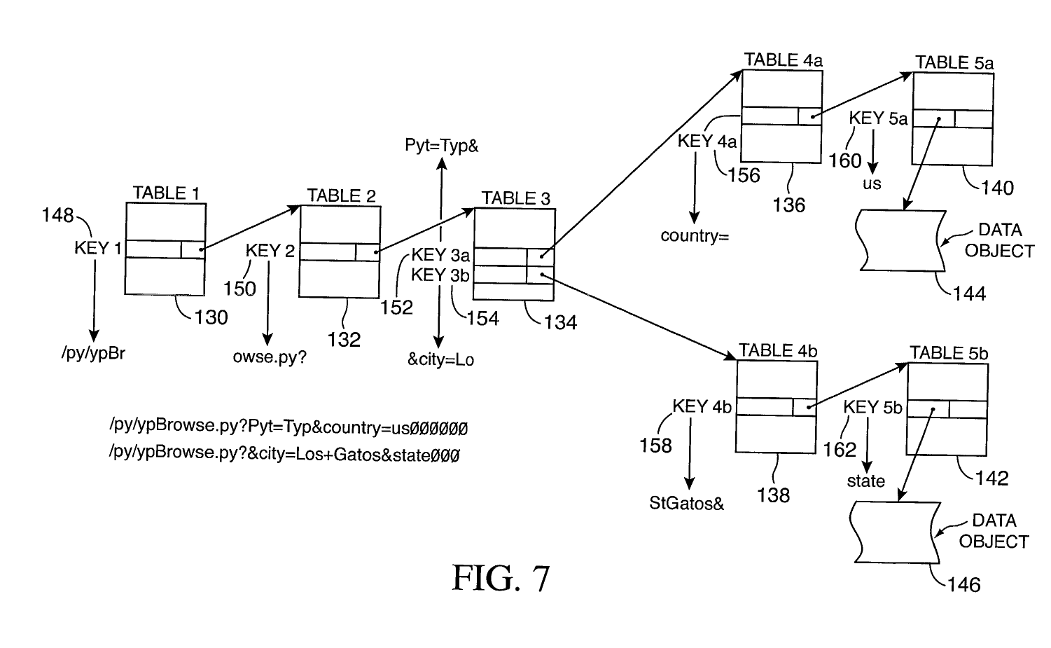

This process is repeated for each string that the server supports. The final result is a “tree” of tables with entries for each segment of each URI. For example, referring to FIG. 7, which shows a chain of tables 130, 132, 134, 136, 138, 140, 142 corresponding to two input strings, there are two URIs (or relevant portions thereof), /py/ypBrowse.py?Pyt=Typ&country=usØØØØØØ and /py/ypBrowse.py?&city=Los+Gatos&stateØØØ that have the same first (8 character) segments, /py/ypBr, and the same second segments, owse.py? The first segments will have the same key, key1 148 and the second segments have the same key, key 2 150. Both URIs are represented by the same entry in the first segment table 130, the root of the tree and the same entry in the second table 132. The two URIs have different third segments. One has Pyt=Typ& and the other has &city=Lo. These segments are represented by two different entries in the third table 134. One entry, Pyt=Typ&, points to table 4a 136 and the other entry, &city=Lo, points to table 4b 138. Table 4a 136 has an entry for the key 156 that corresponds to the next segment of the first URI, country=, and table 4b 138 has an entry for the key 158 that corresponds to the next segment, s+Gatos&, for the second URI. Table 4a 136 then points to table 5a 140 which has an entry corresponding to the last segment of the first URI, usØØØØØØ (which is padded with nulls to become 8 characters). This entry points to the data object 144 corresponding to the URI, which is a map of the U.S. Table 5b 142 has an entry corresponding to the last segment of the second URI, stateØØØ. This entry points to the data object 146 corresponding to the URI, which is a map of the town of Los Gatos, Calif. As more URIs are processed in accordance with the above steps, more branches to the tree of tables are included. The root of the tree contains entries for the different first segments of all supported URIs. The next level in the tree contains as many separate tables as there are URIs with different first segments and each table at the second level contains as many entries as there are URIs with the same first segments and different second segments.

Given the large number of tables that could be included a table tree it is important to consider the size and number of tables that fit in a given amount of memory. Table A format has the advantage that a table can be located anywhere in the memory, but requires larger table entries than the Table B format. Each entry in format A is the twice the size of an address for the memory. This means that a memory having a 32 bit address the entry size is 8 bytes and the size of a table is 2 ^{key size}*(entry_size) which equals 128 bytes for a 4 bit key and 32,768 bytes for a 12 bit key. On the other hand, a table in format B has an entry size of 6 bytes if a 2 byte number is used in the next table pointer field. Thus for a 4 bit key each table is 96 bytes and for a 12 bit key the table is 24,576 bytes, i.e., ¾ of the space as compared with format A. While tables in format B are smaller for a given key size, these tables must be placed in a given order in the memory. However, this is not a serious constraint for the savings in space achieved.

After a tree of tables, such as is shown in FIG. 7, is constructed in a memory residing in the server, processing of an incoming string follows the tables to find the object corresponding to the input string.

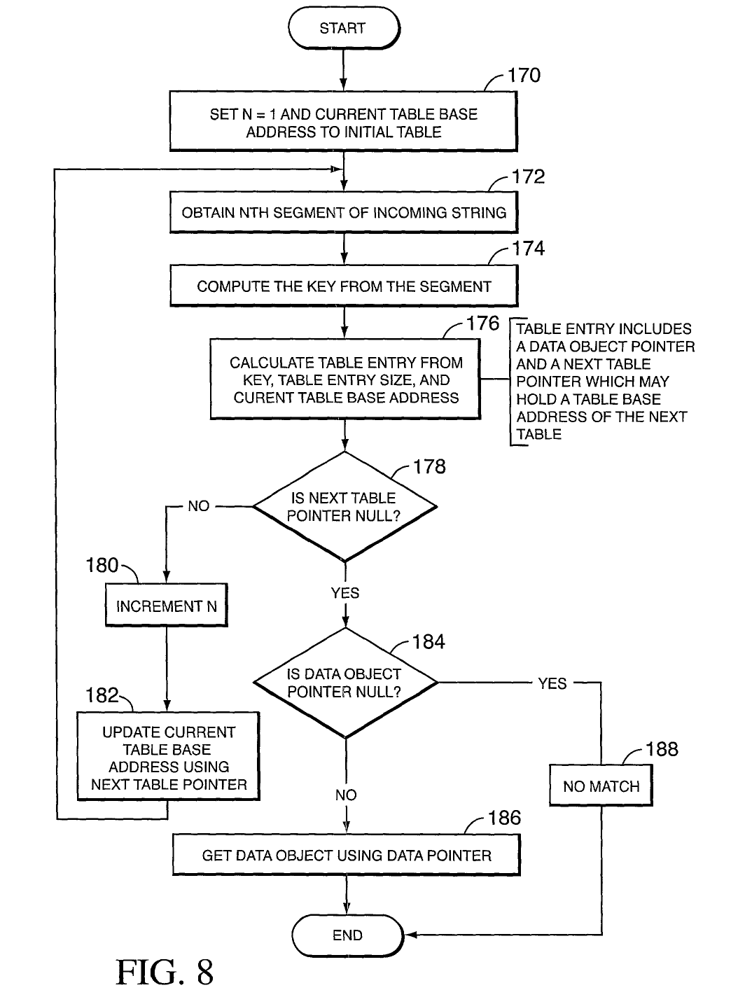

FIG. 8 shows a flow chart for locating a data object corresponding to an input string in accordance with the present invention. In step 170, a counter n, for tracking the segment position within the input string, is set to 1, and the current table base address is set to the base address of the initial or root table. The first (n=1) segment is now obtained, in step 172, from the incoming string and a key is computed, in step 174, for the first segment. Having the computed key, the address of the entry in the first (n=1) segment table is calculated, in step 176, using the key, the entry size (a known constant) and the current table base address (the initial or root table). The entry, containing next table pointer and data object pointer fields, in the table is retrieved and tested in step 178 to determine whether or not the next table pointer is null. If not, there is another table to examine. The counter n is incremented, in step 180, and the current table base address is updated, in step 182, to be the table base address contained in next table pointer field of the retrieved entry. Now the second (n=2) segment (for the string) is obtained in step 172 and the key for the second segment is computed, in step 174. Next, the entry in the second segment table is computed, in step 176, by using the updated table base address and the newly computed key. The entry is obtained and tested, in step 178, to determine whether or not the next table pointer field is null. If so, then there are no more tables to examine and the data pointer field is tested, in step 184. If the data pointer is not null, then it points to the data object associated with the incoming string thus allowing its retrieval in step 186, and transmission to the requester. If the data pointer field is null, then there is no match, as shown in step 188, and the search ends with a miss.

The above process for locating a data object corresponding to the input string is simple enough to be carried out by hardware or a dedicated computing element such as an embedded microprocessor. Calculating the key using a CRC polynomial is relatively quick in hardware or a dedicated computing element with an ALU. Calculating the entry location is simple as well, only involving one multiplication (which can be performed by a shift if one of the factors is binary) and one addition. Because the algorithm does not involve complex calculations, the process for locating the data object can be carried out in real time (say, for example, in a processing pipeline) as the input string is received by the server. This means that by the time the complete string has been received by the server, the data object corresponding to the string has already been found, thus speeding the retrieval process faced by the server.

Although the present invention has been described in considerable detail with reference to certain preferred versions thereof, other versions are possible. Therefore, the spirit and scope of the appended claims should not be limited to the description of the preferred versions contained herein.

What is claimed is:

1. A method of locating a data object using a plurality of tables, wherein each table has a table base address and one or more entries that include a data object pointer and a next table base address, wherein the data object is specified by an input string that is divided into an ordered set of two or more segments, a segment being a predetermined length of the input string and corresponding to an entry in one of the plurality of tables, the method comprising, for each segment in the ordered set:
obtaining the segment from the input string;
calculating a key for the segment;
obtaining a table base address of the table positioned to have an entry for the segment in the input string;
computing a location of an entry in the table based on the key and the table base address of the table; and
obtaining the entry and determining from the entry either the data object corresponding to the input string or the table base address of a table containing an entry for the next segment of the input string.

2. A method of locating a data object as recited in claim 1,
wherein one of the tables has an entry corresponding to a previous segment of the input string; and
wherein the step of obtaining a table base address includes:
obtaining the entry from said table; and
accessing the next table base address from said entry.

3. A method of locating a data object as recited in claim 1,
wherein one of the tables is a root table that contains entries for the first segments of input strings; and
wherein the step of obtaining a table base address includes obtaining the table base address of the root table.

4. A method of locating a data object as recited in claim 1,
wherein the input string is received by a computer system; and
wherein the step of obtaining the segment from the input string includes capturing the segment as it is received in real time by the computer system.

5. A method of locating a data object using a plurality of tables, wherein each table has a table base address and one or more entries that include a data object pointer and a next table base address, wherein the data object is specified by an input string that is divided into an ordered set of two or more segments, a segment being a predetermined length of the input string and corresponding to an entry in one of the plurality of tables, the method comprising:
(a) setting a current table to the first segment table, a current table base address to a first segment table base address and a current segment to the first segment of the input string;
(b) computing a key for the current segment;
(c) determining the location of an entry in the current table based on the computed key of the current segment and the current table base address;
(d) obtaining and testing the next table base address of the entry in the current table;
(e) if the next table base address of the entry in the current table is not null, setting the current table to the next table, the current table base address to the contents of the next table base address, and the current segment to the next segment in the string and continuing at step (b);
(f) if the next table base address of the entry in the current table is null and the data object pointer is not null, obtaining the data object using the data object pointer; and
(g) if the next table base address pointer of the entry in the current table is null and the data object pointer is null, returning an indication that there is no data object corresponding to the input string.
